(19) United States
(12) Patent Application Publication
(10) Pub. No.: US 2019/0301509 A1
(43) Pub. Date: Oct. 3, 2019

(54) Anchor Plug with Prefilled Adhesive

(71) Applicant: Daryl George Philip, Akron, OH (US)

(72) Inventor: Daryl George Philip, Akron, OH (US)

(21) Appl. No.: 16/372,312

(22) Filed: Apr. 1, 2019

Related U.S. Application Data
(60) Provisional application No. 62/651,175, filed on Apr. 1, 2018.

(51) Int. Cl. F16B 13/14

(52) U.S. Cl. CPC F16B 13/141

(57) ABSTRACT

A ready to use composite anchor plug kit, pre-assembled with adhesive/s or compounds (20, 21) and spill catchment film (11), which does not need separate adhesive/s or compounds to be inserted, injected or applied in or on the body of the anchor plug for the purposes of increasing the resultant anchoring strength. The anchor plug has a detachable, adhesive backed, spill containment and collection film (11) designed to protect the immediate surrounding surface work area from the extra adhesive (20, 21) seeping out. The adhesive (20, 21) overspill is collected on the film surface, which can be detached & discarded, thereby ensuring a neat & clean uncontaminated area around the anchored borehole.

The body of the anchor plug (16) is sealed with a pressure retaining diaphragm seal plug (15) with self-sealing, leak-proof properties, designed to retain the generated pressure within the cavity of the anchor plug (16), after it is pierced and threaded through with an anchor.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A “SEQUENCE LISTING,” A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC

Not Applicable

### BACKGROUND OF INVENTION

### Cross References to Prior Art

Applicable U.S. patent classification is CCL/“411”/82.3
1. PUB. APP. NO. 20120282059: Adhesive package and use thereof with an anchoring element
2. PUB. APP. NO. 20100284762: Self-drilling fastening element
3. PUB. APP. NO. 20090290952: Fastening element
4. PUB. APP. NO. 20090158678: Injection-securable anchor and anchor tube for the injection-securable anchor

Referenced Cited: U.S. Patent Documents

| | | |
|---|---|---|
| 3,618,326 | November 1971 | Montgomery |
| 5,282,697 | Feb. 1, 1994 | Maechtle |

### FIELD OF THE INVENTION

The present invention generally relates to an anchor plug for anchoring an anchor in a borehole drilled into a substrate and to be chemically anchored in any substrate in the field of construction, manufacturing industries, do-it-yourself projects, recreational activities like rappelling and rock climbing, etc.

### DESCRIPTION OF THE PRIOR ART

General hollow anchors of the above-mentioned general type also commonly known as anchor plugs or as an anchor plug, is a fibre or plastic or wood insert used to enable the attachment of a screw in material that is porous or brittle or that would otherwise not support the weight of the object attached with the screw. It is a type of anchor that, for example, allows screws to be fitted into masonry walls.

There are many forms of anchor plug, but the most common principle is to use a tapered tube of soft material, such as plastic. This is inserted loosely into a drilled hole, then a screw is tightened into the centre. As the screw enters the plug, the soft material of the plug expands conforming tightly to the wall material. Such anchors can attach one object to another in situations where screws, nails, adhesives, or other simple fasteners are either impractical or ineffective. Different types have different levels of strength and can be used on different types of surfaces.

The current two primarily used fastener anchors in industries and for general use are, a mechanical type and an adhesive based anchor bolt. Both having their own advantages and disadvantages. Mechanical anchor bolts are quick to install with a major disadvantage being that when at the time of insertion, if the concrete is not fully cured and set, the bolt will not firmly anchor itself to the concrete or will cause small internal cracks within the concrete, thereby decreasing the concrete's long-term structural integrity. Adhesive anchor bolts have the advantage of being chemically fastened to the substrate, thereby eliminating the structural and mechanical issues of the previous, but having disadvantages of increasing costs for the preparation, application and cleaning up after installation.

Conventional fastener anchors do not anchor firmly to the insides of drilled holes, due to a variety of reasons such as:

The drilled hole is larger than the anchoring dimensions of the fastener anchor,
The substrate around the hole does not have the grit strength to hold the fastener anchor.
The forces exerted on the fastener anchor is far greater than the circumferentially anchoring strength of the fastener anchor.

With time, the mating/anchoring points between the substrate and the fastener anchor slowly disintegrates and the fastener anchor becomes loose. This happens due to the gap between the substrate and the fastener anchor permitting the ingression of moisture, pollution, degrading both surfaces thereby leading to loss in stability of the joint.

Before commercial anchor plugs, fixings were made to brick or masonry walls by chiselling a groove into a soft mortar joint, hammering in a crude wooden plug and then attaching to the wooden plug. This was time consuming and required a large hole, thus more patching of the wall afterwards. It also limited the holes' location to the mortar joints.

Early anchor plugs were thick-walled fibre tubes, made of parallel strings bonded with glue. Plugs were also made of lead, zinc, natural and synthetic rubber, hemp fibres, glass, wood, and paper.

Some varieties of anchor plug are mechanical anchors for heavy duty loads and hollow wall fixings for fixing to plasterboard.

Nowadays, one of the most common designs for light loads is the split-ribbed plastic anchor. It consists of two halves that increase their separation (split) as the screw penetrates between them. As its name suggests, this type of anchor also has ribs on the outside to prevent the anchor from slipping out of the hole as the screw is driven in. This type of anchor is also known as a conical screw anchor.

Fibre and resin mixes: On crumbling walls it may be difficult to drill a clean hole, or the force of the expanding plug may be enough to cause cracking. In these cases, a hardening liquid or putty mixture may be used instead.

One of the first of these mixtures was composed of dry white asbestos fibres, sold loose in a tin. The user wetted some into a ball (usually by spitting on them) and pushed this plug of putty into the hole. A small tamper and spike were supplied with the kit. This putty worked very well, but the hazard of the asbestos fibres means that the product is no longer available. However, another way to fix anchor plugs is accomplished by the application of a cotton woven pad which has been impregnated with a special formulated gypsum to bond into the wall. The pad is wetted and wrapped around the anchor plug, and the two are inserted into the hole; after a short time it hardens and a strong bond is achieved and the wall fitting can be applied. It is used in combination with anchor plugs in masonry, ceramic, wood and plasterboard walls.

Modern resin mixtures are based on polyester resins. Apart from their use in construction, they're also used in climbing.

Hollow walls: There are special fasteners for hollow walls such as plasterboard partitions, which are not thick enough to take anchor plugs. The fasteners have toggle arms, which either drop into place or expand within the cavity, and a fixing screw which is threaded through them.

Expansion anchors/Anchor bolt/Wedge Anchor/Sleeve Anchor/Undercut Anchor/Lead anchors/Plastic anchors are used as follows:

Drill a hole the same size as the anchor body.

Push the anchor to its full depth in the hole.

Insert the screw through the item being fastened and screw it into the anchor tightly.

Other types: Anchors designed especially for fastening to hollow walls, include toggle bolts and molly bolts. These wall anchors are also known by other names, such as, “tacos”, drywall hangers, expansion nuts, etc.

It is known that it is notoriously difficult to provide strong and secure screw fastening into a wall of plasterboard, otherwise known as drywall, wallboard, plasterboard, gypsum board. Pressed gypsum plaster between two paper surfaces in such plasterboard provides an easily mounted “dead” (i.e. non-moving, such as wood) wall in which cracks under paint or wallpaper will not appear, as can be the case with wood. One of the disadvantages of plasterboard is that it has no wood fibres to securely hold screw threads when mounting a shelf for example on such a wall. The wooden studs inside the wall are often inconveniently placed or spaced too far apart for mounting the shelf for example. Slightly barbed or ribbed plastic plug anchors have been used, which are pushed into a hole drilled in the plasterboard, where after the fastening screw is screwed into it, expanding the plug slightly and increasing the holding force. Even moderate loads however may easily cause failure, with the screw, anchor and often the surrounding paper and plaster being ripped out of the wall. If the wall shelf is removed, it is very difficult to remove such plug anchors without creating large unsightly holes in the wall.

If one had access to the interior of the wall behind the sheet of plasterboard it would be easy to place a large area washer or a plate before the nut on the fastening screw thus spreading the load on the plasterboard over a much larger area and permitting the plasterboard to support a much larger load, from the shelf for example, without being pulled out of the wall. But shelves, TV brackets, lamp brackets, hooks etc. are usually mounted long after the original wall construction, with the wall being closed and painted or wallpapered. Thus there are quite a number of plasterboard anchors which are designed to be inserted through a drilled hole of acceptable diameter in the plasterboard and then, completely unseen behind the wall plasterboard sheet, either expand flexible sides of a nut element, as some anchors do, or toggle a winged nut element to a position perpendicular to the fastener screw and behind the plasterboard sheet as toggle bolts do. With a toggle bolt, the wings of the toggle nut are folded against a machine screw during insertion into a drilled hole in the plasterboard so that the folded toggle wings completely clear the plasterboard sheet into the wall, whereupon the machine screw is tightened, thereby spreading the toggle wings. This toggle bolt solution requires metal pin axles for the wings on the nut, making this metal element relatively expensive and complex to make.

Also, all these previously mentioned types of wall screw anchors, require a number of separate steps to secure the anchors: drilling a hole of appropriate diameter, inserting the unexpanded anchor into the drilled hole, tightening a machine screw for expansion or folding out.

Any speeding up of this process may provide significant savings in time and effort of installation.

To this end, self-drilling anchors have been developed, where the drill bit after drilling serves a toggle nut to be disposed within the wall at right angles to the fastener screw for tightening up. Four such prior art solutions are described in EP0998635, US2009/0003962, U.S. Pat. Nos. 6,435,789 and 7,611,316 where a drill point in alignment with a screw collar and two shanks is provided with a cross screw head for rotation of the drill point for drilling through the plasterboard. When it has penetrated fully, the drill point is disposed to swing 90° in relation to the shanks to present a screw hole for the fastening screw, which, when tightened up now utilizes the drill point as a perpendicular behind the wall toggle. All of these designs require shanks with means to guide and pivot the drill point to its perpendicular position presenting the nut hole for the screw. This type of anchor, although somewhat complex appears to function when the space inside the wall is hollow. When the space behind the sheet of plasterboard is filled with insulation, the drill point with stick in the insulation and not move to the perpendicular position. The fastening screw will in this case often miss the hole, resulting in a very unsatisfactory fixing of the fastener screw.

US 2008/0253860 describes a similar construction but where the drill point toggle is spring biased towards its perpendicular position in an attempt to remedy the problem with a wall filled with insulation. In this prior art design, after drilling, the separate collar is ratcheted down a plastic trough sandwiching the plasterboard between the toggle and the fastening screw, which rests in the plastic trough and is slid therein towards the toggle, hopefully in alignment with the threaded hole, which is not always the case if the toggle element is impeded by insulation. The user is required to push the collar down the ratcheted trough and to break off the protruding portion of the trough. Assembly is complicated. It requires the installation of a spring means and is dependent on small pivot pins interacting with very small pin recesses in plastic. The construction is not robust perhaps prone to breakage (pivot pins). And this design still does not guarantee that the distal end of the fastening screw or bolt will enter the threaded hole, should the toggle not be aligned perpendicular to the trough Small pieces of insulation can easily come between the parts of this known anchor assembly when inserted, thereby preventing the anchor from assuming its perpendicular alignment position.

One of such anchors is disclosed for example in the European patent document EP-A-502348.

The composite anchor disclosed in this reference has a cartridge with a mineral mortar as one component and water as another component located in an inner container. The container has individual container sections which are distributed along its length and are individually crushable when the anchoring rod is driven in. Due to the distribution of water components over the entire length of the cartridge, the mortar is uniformly saturated with water and good mixing and hardening is to be achieved. However, the inner container has a very complicated construction and several uniformly distributed small containers for water which in some cases still have to be distributed in the cartridge with the aid of positioning means. Despite its very complicated configuration, it is still impossible to prevent an uneven distribution of the water component and some escape of the water, at least at the anchoring rod is put into position. As a result, the bonding agent is incompletely mixed especially with horizontally running bores and even more in overhead installations. The holding values of the anchoring rod are therefore extremely inconsistent and present a corresponding safety risk.

For chemical anchoring of a fastening element such as anchor rod, threaded rod, threaded sleeve, screw anchor, or reinforcement bar in a substrate such as a constructional component or a workpiece, a borehole is produced, cleaned, and filled with a harden-able compound which advantageously includes multiple components, e.g., a two-component mortar compound. The fastening element is then set in the filled borehole. After the compound hardens, the fastening element has high load values. Unlike mechanically anchored fastening elements, fastening elements of the kind described above are anchored in the substrate without expansion forces so that there is the possibility of small edge distances and axial distances of the anchored fastening element in the substrate. Mounting parts are secured to the substrate, for example, by nuts, at the free end of the fastening element anchored in the substrate.

EP 0 150 555 A1 discloses a fastening element with a mixing knife that forms a mixing element. The fastening element is introduced into a borehole outfitted with a cartridge. When the fastening element is screwed in, e.g., with a rotary driving device, the cartridge is destroyed, and the components of the harden-able, multi-component compound are mixed together.

As was stated, for example, in DE 34 42 383 A1, it was considered essential in technical circles up until now to clean the borehole prior to introducing the harden-able multi-component compound, which represents a substantial expenditure for producing the attachments, particularly for series applications.

Fastening elements of the type described above, e.g., a rock anchor, serve for stabilization of hollow spaces such as tunnels, galleries, and the like and, namely, for attaching walls of adjacent rock regions to each other.

In many cases, it is proceeded from the premise that the regions in the immediate vicinity of the walls have, as a result of formation of hollow spaces, reduced mechanical characteristics, in particular, a reduced load carrying capacity than further, remotely located, non-damaged rock regions, and should be attached to the remotely located regions. Under the term “walls of a hollow space” is understood, in this connection, in addition to ceiling sections and side walls of hollow spaces, also their bottom regions. Further, such fastening elements can be used as links for transmission of large loads.

With a chemically anchorable fastening element according to U.S. Pat. No. 4,303,354, two tubular film bags with harden-able masses, which harden with different speeds, are placed in a preliminary formed borehole, with the tubular bag located adjacent to the borehole bottom, containing a rapidly harden-able composition and with tubular bag adjoining the previous tubular bag, containing a relatively slower harden-able mass. Upon setting of a fastening element, firstly, the tubular bag, which contains the slow harden-able mass is destroyed, and the components contained therein form a first mixture of the harden-able mass. Then, the tubular bag, which contains the rapidly harden-able mass, is destroyed, and the components contained therein form a second mixture of the hardenable mass, with the second mixture starting to harden right away.

The drawback of the known solution consists in that firstly, a borehole should be formed with a separate tool, and the insertion of two tubular bags in each borehole is expensive. In addition, inadvertently, the tubular bags can be inserted in a borehole in incorrect order, so that upon setting of the fastening element, firstly, the tubular bag with a rapidly harden-able composition is destroyed. As a result, a correct setting of the fastening element is not possible any more or possible only to a limited extent.

U.S. Pat. No. 4,055,051 discloses a self-drilling fastening element of the type disclosed above and which is provided with an ejectable mass at its power tool side and can easily be set. The fastening element has a hollow cylindrical body at one end of which a drilling head is provided and in which an ejectable, harden-able multi-component mass is provided. The harden-able mass includes a hardener and a reactive resin, which is kept separate, and which hardens in a mixed condition. In the drilling head, there are provided through-openings for the harden-able mass.

The fastening element according to U.S. Pat. No. 4,055,051 is drilled into a constructional component. After a desired setting depth is reached, the hardenable mass, which is stored in a film container, is ejected under pressure, with a mixture being formed upon passing through the openings in the drilling head, and filling the space surrounding the fastening element. After hardening of the harden-able mass, the fastening element is chemically anchored in the constructional component.

The drawback of the fastening element of U.S. Pat. No. 4,055,051 consists in that the fastening elements cannot be loaded until the harden-able mass hardens.

Accordingly, an object of the present invention is to provide a chemically anchorable fastening that can be easily and reliably set and that can be rapidly loaded up to a predetermined level.

Fastening elements for chemical anchoring in a substrate are known from the prior art from U.S. Pat. No. 4,303,354, for example. In the case of this anchoring element, two foil pouches having masses that can harden at different rates are introduced into a drill hole that has been created prior to this, with the foil pouch facing the base of the drill hole containing a rapidly hardening compound and the subsequent foil pouch containing a compound that hardens comparatively slower. When introducing the fastening element, the pouch with the slower hardening compound is destroyed first and the components contained therein are mixed to form a first harden-able mass. Then the foil pouch with the rapidly hardening compound is destroyed and the components contained therein are mixed to form a second harden-able mass, wherein the components begin to harden immediately, while the first mass hardens with a time lag.

German Patent Document No. DE 10 2009 002 951 A1 shows a self-drilling rock anchor having a hollow cylindrical receiving body, which has a drill head on one end and in which an extrudable, multi-component mass is provided. The multi-component mass comprises at least one hardener component and at least one reactive resin component, which are kept separate from each other and harden in a mixed state. Passage openings for the multi-component mass are provided in the area of the drill head. The reactive resin component comprises two different compounds, which are arranged in succession, wherein the second compound of the reactive resin component, which hardens rapidly in the mixture with the hardener component, is arranged behind the first compound of the reactive resin component with respect to the drive-in direction of the fastening element, which first compound hardens more slowly in the mixture with the hardener component than the second compound.

The hardener component and the reactive resin component are normally accommodated in separate chambers of a tubular foil pouch. The foil pouches are sealed on their ends by means of metal wire or metal clips. Wires made of aluminium, iron or copper are typically used for this. However, the tying off and sealing of the foil pouches with metal wire or metal clips does not represent an absolutely tight seal, because the squeezing of the different foil layers by the metal wire or metal clip may lead to the formation of minute capillary channels in the sealing section of the foil pouch. In addition, the foil skin of the foil pouch may be injured and damaged by compressing the metal wire. In the case of thin foils, granular filler materials contained in the adhesive mass may also injure the foil skin.

Therefore, the invention provides an adhesive package, in which several reactive resin compounds that are harden-able at different rates are preferably contained in a continuous chamber of a foil pouch that is sealed on both ends. After completely emptying the foil pouch and mixing the hardener component with the reactive resin component, at least two masses that harden at differently rates are present. The first mass introduced into the drill hole advantageously hardens at a moderate speed so as not to block the flowing in of the second mass by premature gelling or hardening. The second mass flowing out after the first mass preferably hardens immediately in order to guarantee an initial strength of the connection between the anchoring element and the surrounding rocks.

The adhesive package according to the invention is suitable preferably for use with a fastening element for chemical anchoring. This anchoring element may be designed to be self-drilling or non-self-drilling.

In the case of a use with non-self-drilling anchoring elements, the adhesive package is introduced into a pre-made drill hole in such a way that the second compound points toward the base of the drill hole. Then the anchoring element is introduced into the drill hole and cuts the adhesive package so that the hardener component and the reactive resin component exit and provide at least two parts of the adhesive mass that harden at different rates.

The fastening element is especially preferably a self-drilling rock bolt, which can be designed as a passive anchor or an active anchor.

In the case of an active anchor, the fastening element that is already partially anchored in the substrate via the rapidly hardening part of the adhesive mass may be pre-stressed by a pre-stress element almost directly after the adhesive mass has been completely squeezed out. Because of the time-delayed subsequent hardening of the slowly or moderately reacting first part of the adhesive mass in the pre-stressed area, the pre-stressing of the fastening element is chemically fixed.

In the case of a passive anchor, the drilling motor and the extrusion unit may be removed immediately after completely extracting the adhesive mass and a subsequent fastening element may be placed, because directly after completely squeezing out the adhesive mass at least one partial anchoring of the fastening element is achieved.

The invention also relates therefore to a fastening element for chemical anchoring in a substrate, having a receiving body for an extrudable adhesive mass, wherein a drill head is provided on an end of the receiving body, and an adhesive package according to the invention is introduced into the receiving body, wherein the adhesive package is arranged in the receiving body in such a way that the first compound is adjacent to the drill head and the second compound is adjacent to an end of the fastening element that is opposite from the drill head.

After completely extruding the adhesive mass, at least two different rapidly hardening parts of the mass are present. The first part of the adhesive mass flowing out and formed by the mixing of the hardener component and the first compound hardens at a moderate speed and guarantees the subsequent flow of the second part of the adhesive mass, which is formed by the mixing of the hardener component and the second compound. The second part of the mass that flows out after the first part of the adhesive mass hardens more rapidly than the first part of the mass and immediately in an advantageous manner. This guarantees that the fastening element is rapidly and securely anchored in the substrate, wherein the rapidly hardening part of the adhesive mass comes to rest in the region of the base of the drill hole, thereby guaranteeing an advantageous application of force in the substrate.

Because of the different hardening times of the parts of the adhesive mass, the fastening elements according to the invention may be driven in independent of the temperature of the substrate, whereby the fastening element according to the invention may be used flexibly in particular in tunnel building or underground work. Normally, rapidly hardening masses are used in the case of cold substrates and slowly hardening masses in the case of hot or warm substrates. Because the fastening element according to the invention has at least two parts of the adhesive mass that harden at different rates, a secure anchoring of the fastening element in different substrates is guaranteed.

### Purpose of the Invention

To overcome and to prevent the above problems, adhesive is injected to fill gaps within and outside the fastener anchors. Majority of the times this is done by manually mixing in precise proportions of a two-component epoxy which is then applied with a probe into the hole and a small amount on the fastener anchor itself before insertion into the hole. This is a time consuming and messy exercise, which reduces efficiency, increasing the cost of labour and time in construction sites.

It is apparent that a need exits for a fastener anchor design that eliminates these time consuming and intensive methods and actions to follow pre- and post-fastener anchor insertion.

While drilling holes in the walls at home, most of us have faced problems like the anchor does not anchor firmly to the insides of drilled holes, because the drilled hole is larger than the anchoring dimensions the wall-plug.

This may happen due to a variety of reasons like:
The drilled hole is larger than the anchoring dimensions the wall-plug.
The substrate around the hole does not have the grit strength to hold the anchors of the wall-plug.
The forces exerted on the wall-plugs is far greater than the circumferentially anchoring strength of the wall-plug.

With time, the mating/anchoring points between the substrate & the wall-plug slowly disintegrates & the wall-plug becomes loose. This happens due to the gap between the substrate & the wall plug permitting the ingression of moisture, pollution, degrading both surfaces & leading to loss of stability of the joint.

To overcome & to prevent the above problems, professionals inject epoxy adhesives to fill gaps within 7 outside the wall-plugs. Most of the times they do this by manually mixing in precise proportions, the 2-component epoxy & then applying the same with a probe into the wall-plugs. This is a time consuming & messy exercise, which reduces efficiency, increasing the cost of labour & time in construction sites.

The anchor plug innovation tries to address all these solutions into a one neat convenient pre-assembled package which would eliminate all the above hassles & in a singular process all the above could be achieved.

The anchor plug as a singular device has internal adhesive or compounds, a pressure retaining diaphragm plug and a surrounding spill containment and collection film (11) and using it achieves multiple objectives & leaves no mess behind to clean up.

The present invention relates to a new design of a composite anchor plug with internal prefilled adhesives or compounds.

The fastener anchor plug, particularly, this invention relates to a method and design of adhesive or epoxy material through a fastener anchor. More particularly, the invention relates to a novel design of the adhesive materials to be encapsulated within the designed fastener anchor. Specifically, this invention relates to the novel method and design of the encapsulated adhesive materials to be mated within the fastener anchor with a detachable plastic membrane attached onto the outside of the fastener anchor to collect excess material seepage.

### BRIEF SUMMARY OF THE INVENTION

A ready to use composite pre-packed adhesive anchor plug kit, as a completely pre-assembled unit, without the requirement for a separate or additional adhesive/s or compounds (20, 21) to be inserted, injected or applied from inside or outside the body of the anchor plug for the purposes of increasing the resultant anchoring strength of the anchor plug to the drilled borehole in any substrate when used as an anchoring device.

The anchor plug also has a detachable adhesive backed spill containment and collection film (11) surrounding the immediate surface vicinity of the work area around the borehole plugged with the anchor plug. This spill containment and collection film (11) adheres to the surrounding area around the plugged-in anchor plug & performs the function of spill collection and containment of the extra seeped out adhesive which collects on its surface, to be later detached & discarded, thereby ensuring a neat & clean uncontaminated area around the anchored borehole.

The body of the anchor plug (16) is sealed with a pressure retaining diaphragm seal plug (15) with self-sealing, leak-proof properties, designed to retain the generated pressure within the cavity of the anchor plug (16), after it is pierced and threaded through, with a threaded or a non-threaded anchor (e.g. screw, nail, bolt, etc.).

The forward motion of the anchor breaks the individually encapsulating sheath covers (22) of the encapsulated adhesive/s or compounds (20, 21) packets, thereby releasing the adhesive/s or compounds (20, 21) within the cavity of the anchor body, with its subsequent mixing and activation of the adhesive/s or compounds (20, 21). Due to the subsequent build-up of pressure within the cavity of the anchor body the activated adhesive/s or compounds (20, 21) gets displaced with turbulence and is pushed around throughout the inside of the anchor body & it is also discharged to the outside of the anchor body (16) through the discharge vents/exit orifices (18) and the expansion slots (19) onto the external surface of the anchor body, wherein it fills the gap/spaces between the anchor body & the surrounding substrate.

The pre-packaged adhesive/s or compounds (20, 21) are protected with encapsulated sheath covers (22) which is sturdy enough for long term storage under adverse climatic and environmental conditions, but can be easily rupture to release its contents, due to friction with an inserted anchor in motion.

The body of the anchor plug can also be coated with a catalyst chemical compound over the inside and outside surface of the body of the anchor plug (16), which otherwise would remain inactive, but will catalyse a pre-planned reaction and activate the targeted chemical or adhesive, when released from the confines of its encapsulated protective sheath covers (22) from within the insides of the anchor plug body.

As shown in FIG. 11, 12, 13, 14, 15, the adhesive/s or compounds (20, 21) pack with the diaphragm seal plug (15) and the spill containment and collection film (11) can be used independently with other hollow anchor plugs of suitable dimensions & proportions for the purposes of increasing the resultant anchoring strength of the anchor plug to the drilled borehole in any substrate when used as an anchoring device.

By changing the chemical composition of the substance in the anchor plug, this anchor plug can be used for the purposes of application coating of a protective substance into the anchor plug body to protect the main inserted body from exposure to harsh environments and chemicals.

### BRIEF DESCRIPTION OF THE SEVERAL VIEWS OF THE DRAWING

In the following, the invention is presented in detail by referring to the attached drawings, which are not necessarily drawn to scale, and wherein:

FIG. 1 illustrates the shaded, external isometric view of the anchor plug

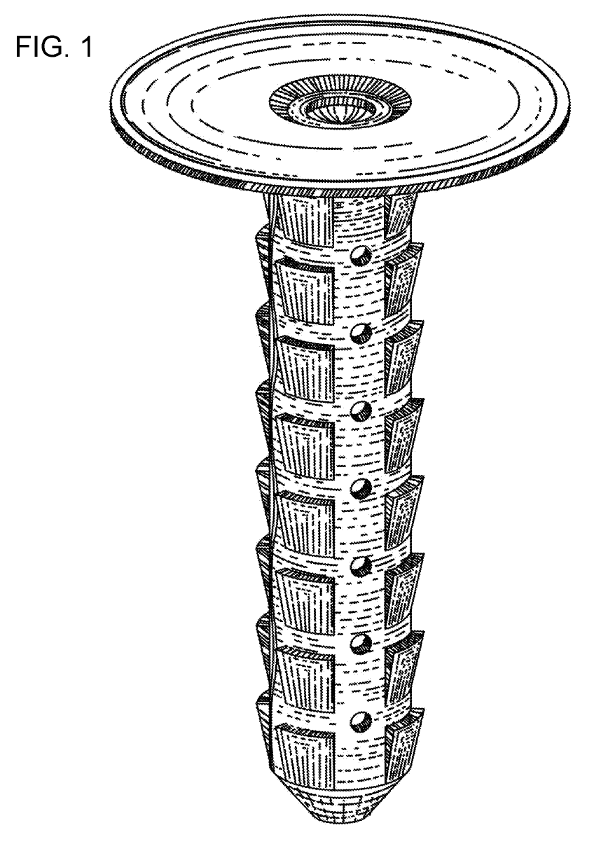

FIG. 2 illustrates external isometric view of the anchor plug, showing the upper/top surface of the spill containment and collection film (11), the raised ridge (12) on the peripheral/circular edge/border of the film (11), the top piercing surface of the diaphragm seal plug (15), the body of the anchor plug (16), the raised interlock ridges (17), the discharge vents/exit orifices (18), the expansion slots (19) and the surface coating of a catalyst chemical compound (23).

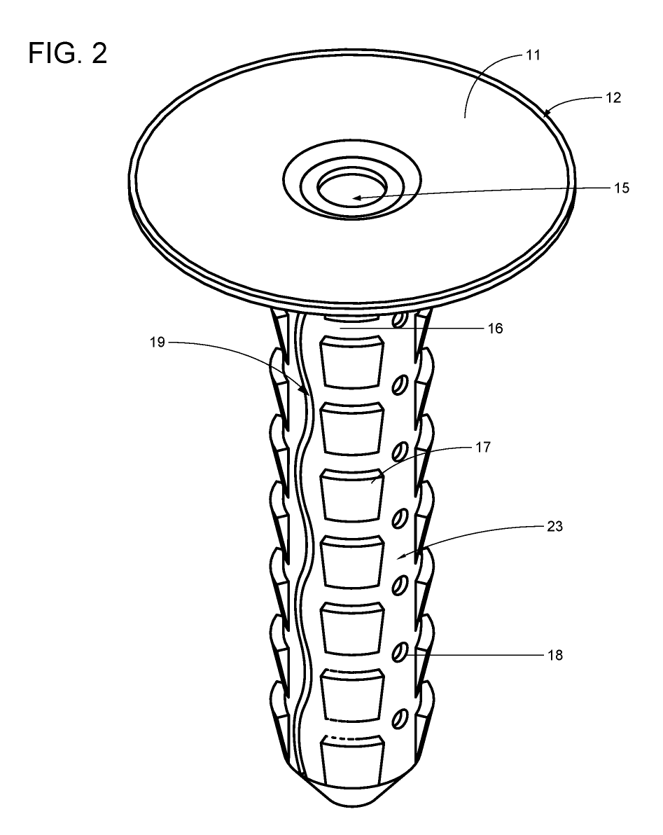

FIG. 3 illustrates the top view of the anchor plug, showing the upper/top surface of the spill containment and collection film (11), the raised ridge (12) on the peripheral/circular edge/border of the film (11), the top piercing surface of the diaphragm seal plug (15).

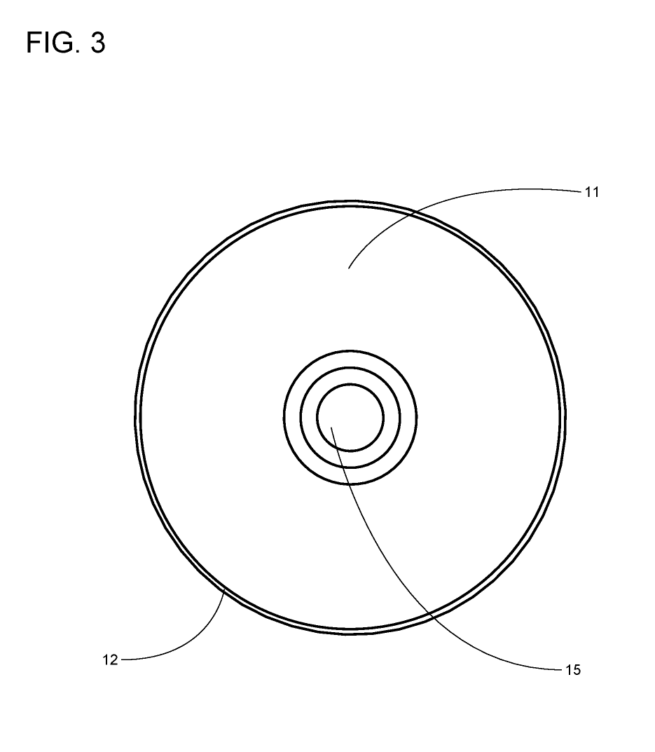

FIG. 4 illustrates a bottom view of the anchor plug, showing the bottom side of the release liner insulating the adhesive coating (14), the body of the anchor plug (16), the raised interlock ridges (17), the bottom discharge vent/exit orifices (18) and the surface coating of a catalyst chemical compound (23).

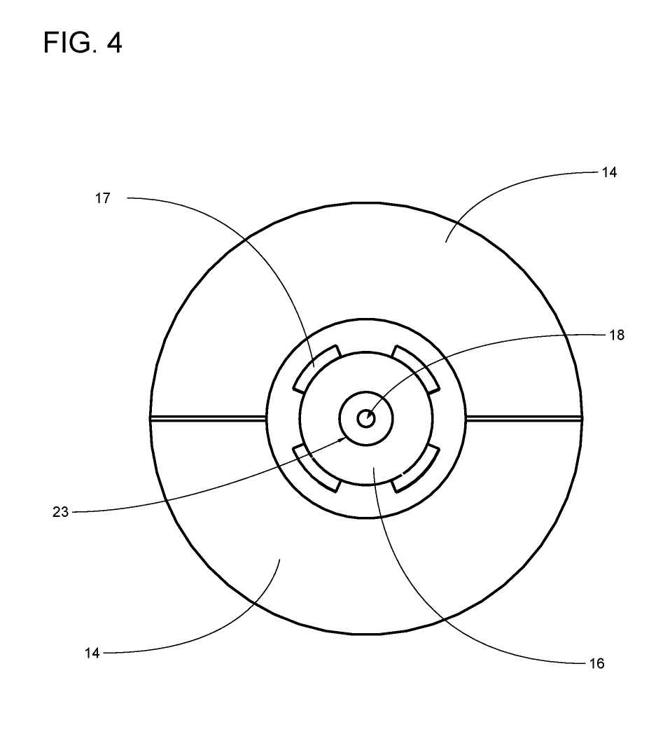

FIG. 5 illustrates an exploded view of the anchor plug, showing the spill containment and collection film (11), the adhesive coating (13), the release liner insulating the adhesive coating (14), the diaphragm seal plug (15), the body of the anchor plug (16), the outside adhesive or compound (20), the inside adhesive or compound (21), the covering/encapsulating membrane (22) over adhesive/s or compounds (20, 21).

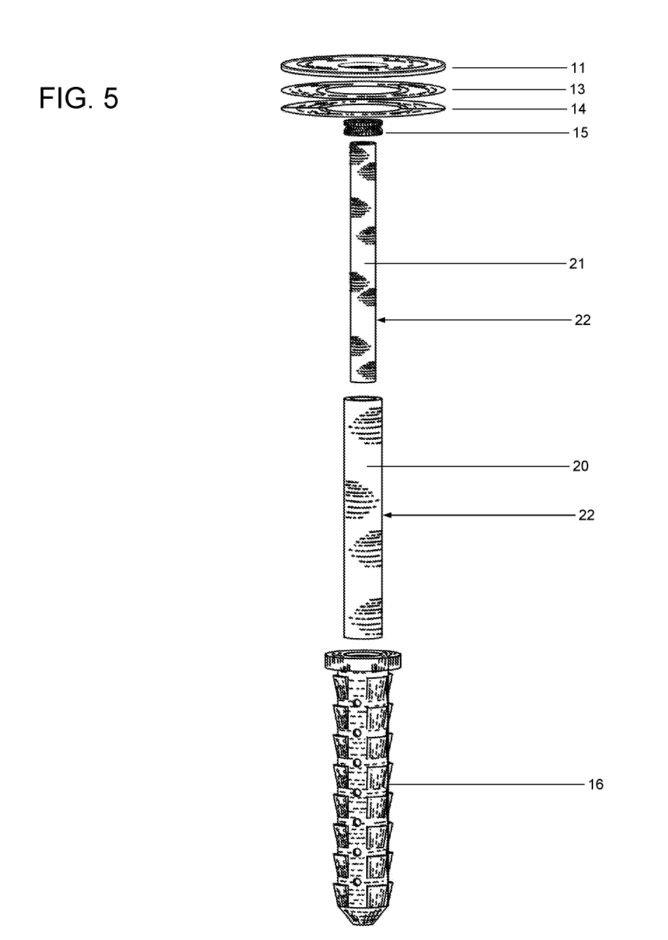

FIG. 6 illustrates the section cuts through planes A-A′, B-B′, C-C′ and section cut through plane D-D′.

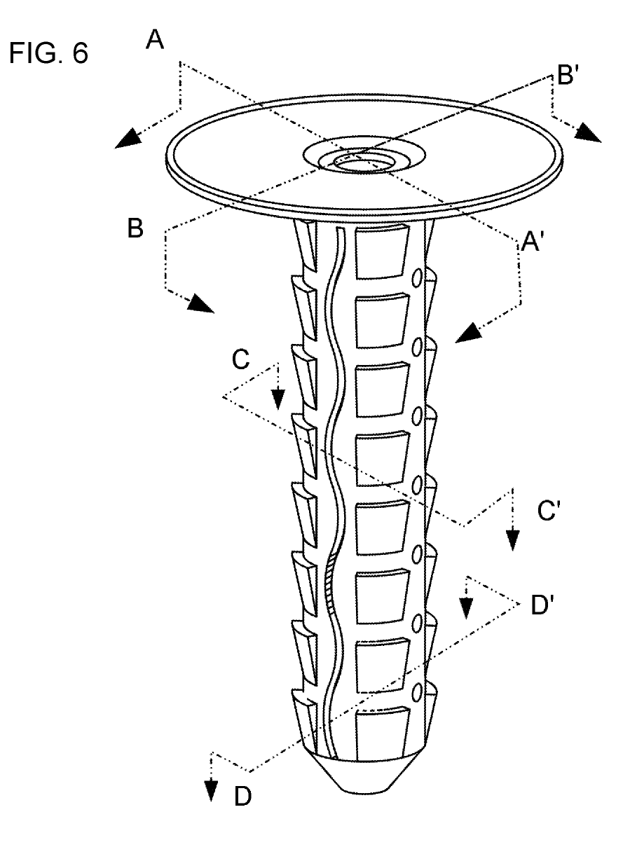

FIG. 7 illustrates the cut section through section plane A-A′, illustrating the cross-sectional areas of the spill containment and collection film (11), the raised peripheral/circular ridge (12), the adhesive coating (13), the release liner insulating the adhesive coating (14), the diaphragm seal plug (15), the body of the anchor plug (16), the discharge vents/exit orifices (18), the adhesive (20), the adhesive (21), the encapsulating protective sheath covers (22) of the adhesive/s and compounds (20, 21) and the surface coating of a catalyst chemical compound (23).

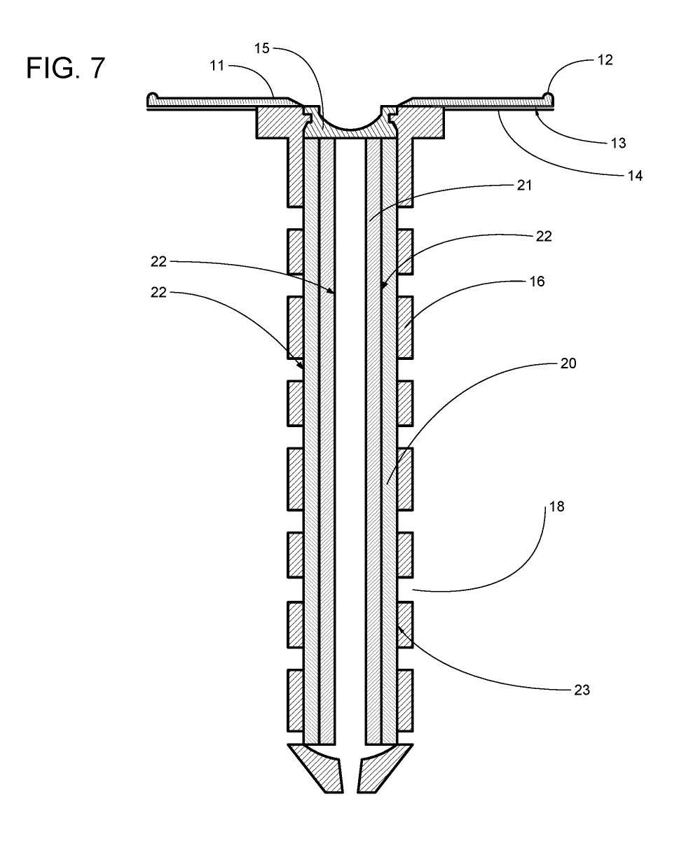

FIG. 8 illustrates the cut section through section plane B-B′, illustrating the cross-sectional areas of the spill containment and collection film (11), the raised peripheral/circular ridge (12), the adhesive coating (13), the release liner insulating the adhesive coating (14), the diaphragm seal plug (15), the body of the anchor plug (16), the raised interlock ridges (17), the adhesive or compound (20), the adhesive or compound (21), the encapsulating protective sheath covers (22) of the adhesive/s and compounds (20, 21) and the surface coating of a catalyst chemical compound (23).

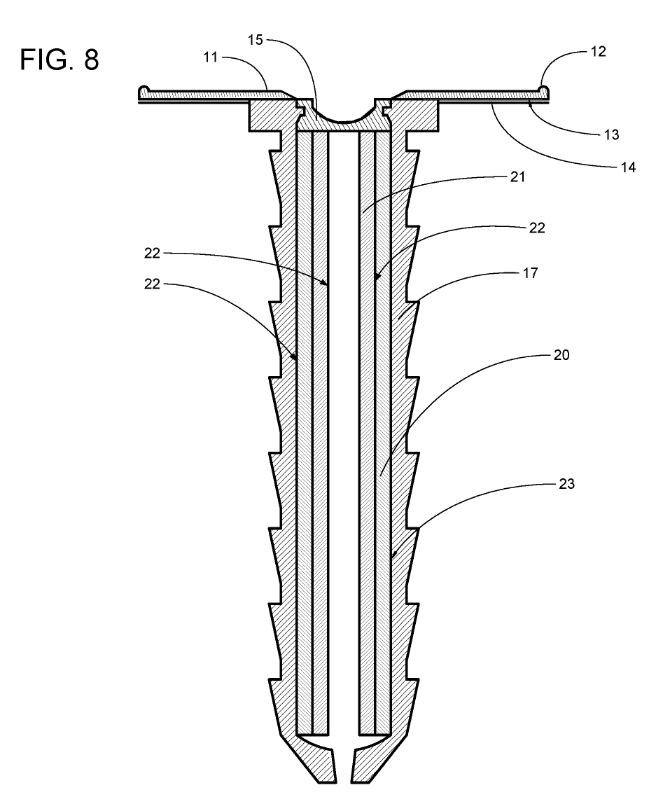

FIG. 9 illustrates the cut section through section plane C-C′, illustrating the cross-sectional areas of the body of the anchor plug (16), the discharge vents/exit orifices (18), the expansion slots (19), the adhesive or compound (20), the adhesive or compound (21), the encapsulating protective sheath covers (22) of the adhesive/s and compounds (20, 21) and the surface coating of a catalyst chemical compound (23).

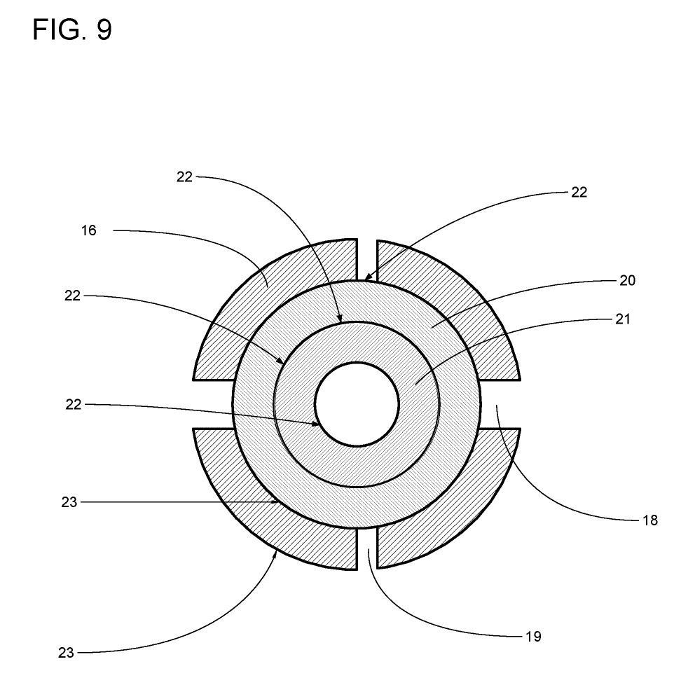

FIG. 10 illustrates the cut section through section plane D-D′, illustrating the cross-sectional areas of the body of the anchor plug (16), the raised interlock ridges (17), the expansion slots (19), the adhesive or compound (20), the adhesive or compound (21) and the encapsulating protective sheath covers (22) of the adhesive/s and compounds (20, 21)

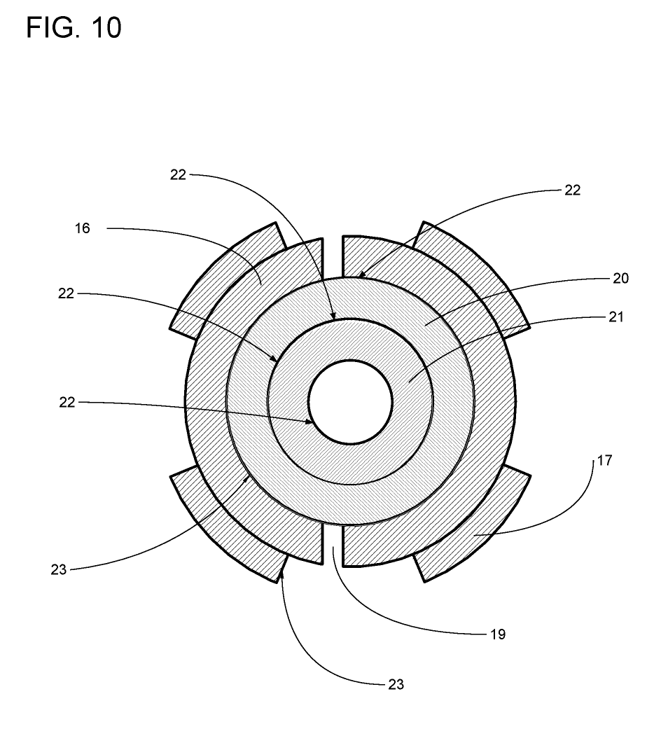

FIG. 11 illustrates external isometric top view of the anchor plug without the body of the anchor, showing the upper/top surface of the spill containment and collection film (11), the raised ridge (12) on the peripheral/circular edge/border of the film (11), the top piercing surface of the diaphragm seal plug (15) and the adhesive (20).

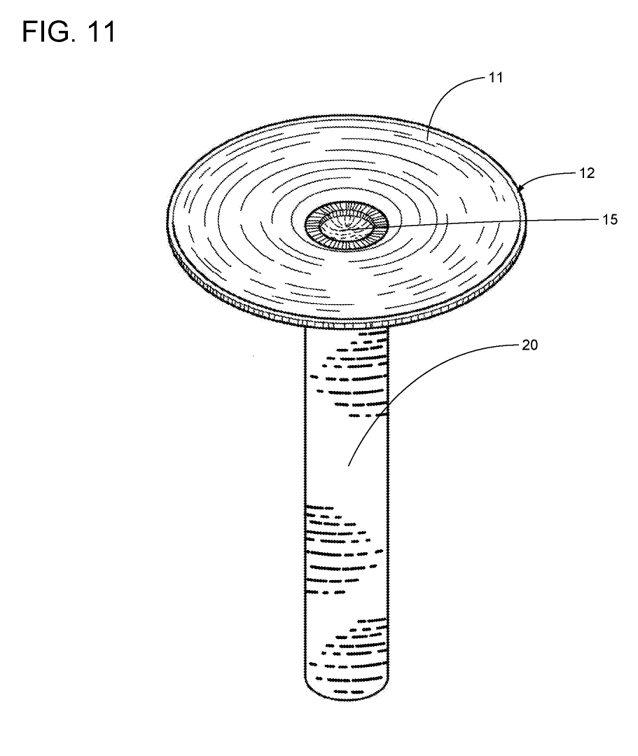

FIG. 12 illustrates external isometric bottom view of the anchor plug without the body of the anchor, showing the bottom surface of the spill containment and collection film (11), the bottom side of the release liner insulating the adhesive coating (14), the diaphragm seal plug (15), the adhesive or compound (20) and the adhesive or compound (21).

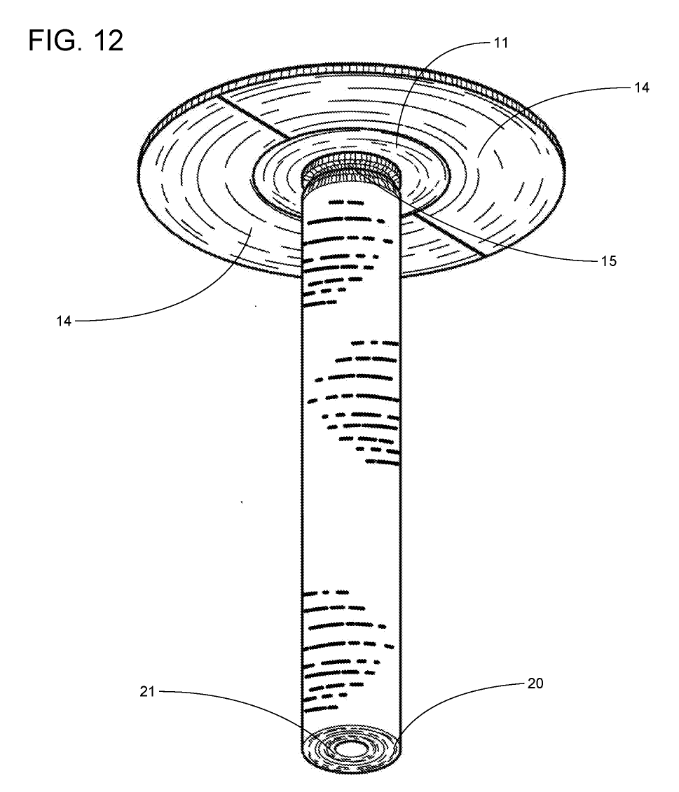

FIG. 13 illustrates the section cuts through plane E-E′.

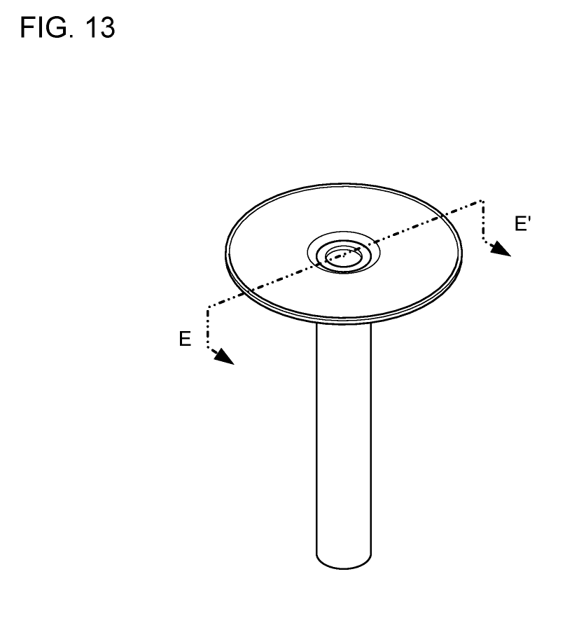

FIG. 14 illustrates the cut section through section plane E-E′, illustrating the cross-sectional areas of the spill containment and collection film (11), the raised peripheral/circular ridge (12), the adhesive coating (13), the release liner insulating the adhesive coating (14), the diaphragm seal plug (15), the adhesive or compound (20), the adhesive or compound (21) and the encapsulating protective sheath covers (22) of the adhesive/s and compounds (20, 21).

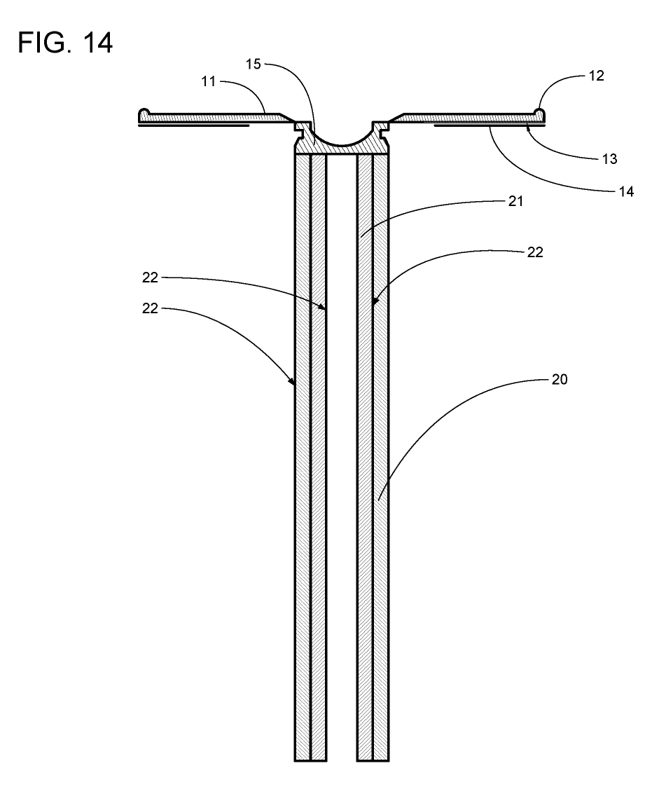

FIG. 15 illustrates the exploded view of the anchor plug's cut section through section plane E-E′, illustrating the cross-sectional areas of the spill containment and collection film (11), the raised peripheral/circular ridge (12), the adhesive coating (13), the release liner insulating the adhesive coating (14), the diaphragm seal plug (15), the adhesive or compound (20), the adhesive or compound (21) and the encapsulating protective sheath covers (22) of the adhesive/s and compounds (20, 21).

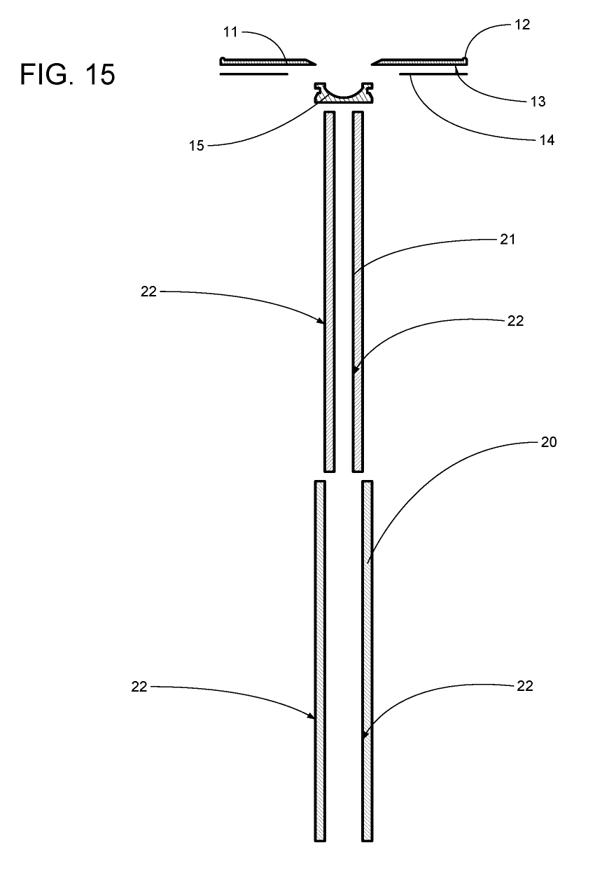

FIG. 16 illustrates the external isometric view of the anchor plug along with its cut section view, for use as the diagram for inclusion on the front page of the patent publication and for the illustration of the invention.

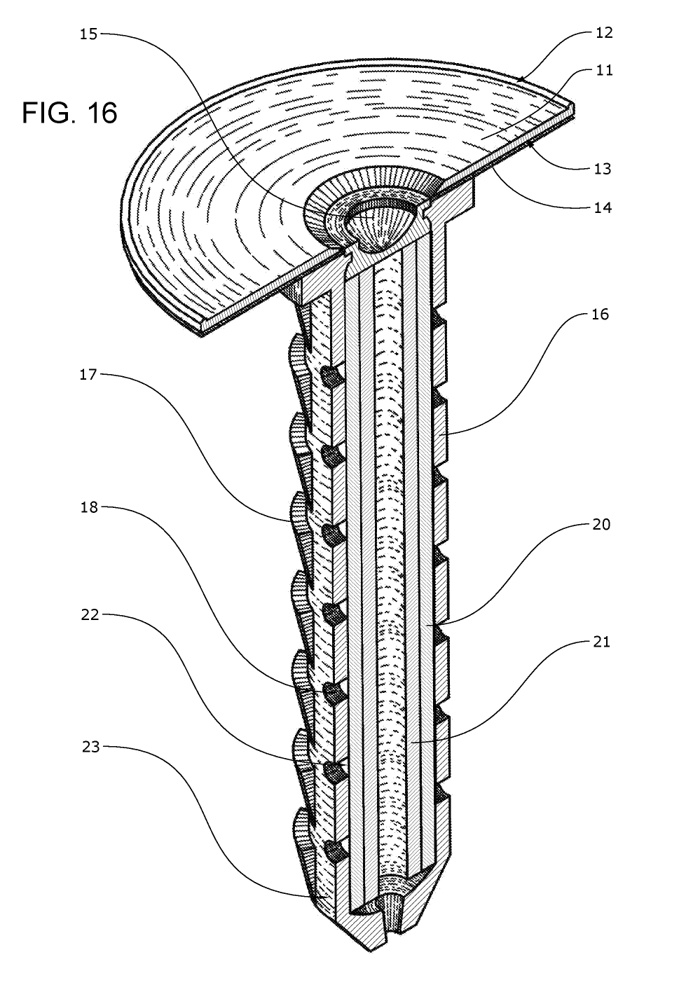

### DETAILED DESCRIPTION OF THE INVENTION

It is the object of the present invention to provide a fastening element which can be anchored in a borehole with quicker speeds, better results, with no clean up required after the application is completed.

Accordingly, the present invention proposes a anchor plug which completely removes the disadvantages of the prior art anchors described above.

The features and advantages of the present invention will be apparent with reference to the following description and attached drawings, describing and showing by way of example only one illustrative embodiment of the present invention.

In keeping with these objects and with other which will become apparent hereinafter, the key features of the anchor plug invention is that it is a pre-assembled and ready to use composite anchor plug kit, complete with the anchor plug body sealed with a pressure retaining diaphragm seal plug (15), adhesive/s or compounds (20, 21) and spill containment and collection film (11), which does not need separate adhesive/s or compounds to be inserted, injected or applied in or on the body of the anchor plug for the purposes of increasing the resultant anchoring strength, and has the pre-fused, but detachable & disposable spill containment and collection film (11), traps seeped out extra adhesive/s or compound (20, 21) and when detached, leaves no residue behind, maintaining the work space neat & clean, with no additional mess to clean up, as captured in the claims 1, 2, 3, 4, 5, 6 and 7.

The pressure retaining diaphragm plug retains the pressure within the plug body & ensures optimal mixing of the adhesive/s or compounds (20, 21) and it prevents leakage of the adhesive/s or compound (20, 21) from the sides of the entry point of the anchor. The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

A ready to use composite pre-packed adhesive or compound, the anchor plug kit, as a completely pre-assembled unit, without the requirement for a separate or additional adhesive/s or compounds (20, 21) to be inserted, injected or applied from inside or outside the body of the anchor plug for the purposes of increasing the resultant anchoring strength of the anchor plug to the drilled borehole in any substrate when used as an anchoring device.

The anchor plug also has a detachable adhesive backed spill containment and collection film (11) surrounding the immediate surface vicinity of the work area around the borehole plugged with the anchor plug. This spill containment and collection film (11) adheres to the surrounding area around the plugged-in the anchor plug & performs the function of spill collection and containment of the extra seeped out adhesive or compound (20, 21), which collects on its surface, to be later detached & discarded, thereby ensuring a neat & clean uncontaminated area around the anchored borehole.

The body of the anchor plug (16) is sealed with a pressure retaining diaphragm seal plug (15) with self-sealing, leak-proof properties, designed to retain the generated pressure within the cavity of the anchor plug (16), after it is pierced and threaded through, with a threaded or a non-threaded anchor (eg. screw, nail, bolt, etc.).

The forward motion of the anchor breaks the individually encapsulating sheath covers (22) of the adhesive/s or compounds (20, 21) packets, thereby releasing the adhesive/s or compounds (20, 21) within the cavity of the anchor body, with its subsequent mixing and activation of the adhesive/s or compounds (20, 21). Due to the subsequent build-up of pressure within the cavity of the anchor body the activated adhesive/s or compounds (20, 21) gets displaced with turbulence and is pushed around throughout the inside of the anchor body & it is also discharged to the outside of the anchor body (16) through the discharge vents/exit orifices (18) and the expansion slots (19) onto the external surface of the anchor body, wherein it fills the gap/spaces between the anchor body & the surrounding substrate.

The pre-packaged adhesive/s or compounds (20, 21) are encapsulated with protective sheath covers (22) which is sturdy enough for long term storage under adverse climatic and environmental conditions, but can be easily ruptured to release its contents, due to friction with an inserted anchor in motion.

The adhesive/s or compounds (20, 21) pack with the diaphragm seal plug (15) and the spill containment and collection film (11) can be used independently with other hollow the anchor plugs of suitable dimensions & proportions for the purposes of increasing the resultant anchoring strength of the anchor plug to the drilled borehole in any substrate when used as an anchoring device.

The said adhesive/s (20, 21) as recited in claim 1, can be a single component adhesive or compound, having a protective sheath cover, to enable it to be stored inertly within the body of the anchor plug (16).

The said adhesive/s or compounds (20, 21) as recited in claim 1, can also be multiple component adhesives or compounds, with each component of the adhesive or compounds having a separate sheath cover as a form of protection to enable it to be stored inertly within the body of the anchor plug (16) and to prevent the different components of the adhesives or compounds, from coming in contact with each other and prematurely getting activated.

The adhesive/s or compounds (20, 21) as recited in claim 1, wherein the said components of the adhesive or compounds, whether an activator, hardener, catalyst, filler, expansion, foaming material, is manufactured as a co-extruded concentric laminar cylindrical tubes, with inert separation layers and ensuring that both its proximal & distal ends are sealed by fusing the ends of its own sheath covers or with a separate independent processes and materials.

The body of the anchor plug can also be coated with a catalyst chemical compound over the inside and outside surface of the body of the anchor plug (16), which otherwise would remain inactive, but will catalyse a pre-planned reaction and activate the targeted chemical or adhesive or compound, when released from the confines of its encapsulated protective sheath covers (22) from within the insides of the anchor plug body.

The spill containment and collection film (11) as recited in claim 1, tethered/fixed around/to the peripheral edge/border of the top of the anchor plug body (16), is an integral part & supplement to, the functioning of the central diaphragm seal plug (15) system, and together they enhance the retainment of the adhesive/s or compounds (20, 21), inside the body of the anchor plug (16) and prevents the backflow of the adhesive/s or compounds (20, 21) from the gaps around the point of entry of the threaded or non-threaded object (screw, nail, bolt, etc.), when passing through the diaphragm seal plug (15) into the internal spaces of the anchor plug body (16).

Referring to the thin encapsulating membrane embodiments of the adhesive/s and compounds, the preferred material for encapsulating them would be a thin polymer like material to provide the required structural integrity to the compartments as well as allow for the ease to be pierced through by a screw or bolt. This would allow for the even mixing of the adhesive/s or compound or the hardener materials and to help them seep out evenly through the various slots of the fastener anchor and allow for this mixture to flow over the surface of the threads of the screw or bolt, so as to facilitate a better bond between the screw and the fastener anchor itself.

By changing the chemical composition of the substance in the anchor plug, this the anchor plug can be used for the purposes of application coating of a protective substance into the anchor plug body to protect the main inserted body from exposure to harsh environments and chemicals.

The pre-assembled and pre-packed adhesives and compounds (20, 21) would give the anchored joint substantial benefits of an increase in the strength of the anchoring. The adhesive/s and compounds (20, 21) would penetrate the micro pores within the concrete (around the hole) & hold all the grit particles together, permanently fusing them to each other. This would prevent them from crumbling & dislodging, thereby extending the life & performance of the anchored wall-plug & ensuring an extreme long performance life to the bolt/screw within & the substrate it is attached to.

The anchor plug with chemical compounds with or without the adhesive/s, offers in addition to a stronger anchoring bond the following advantages of prolonging the ageing of the anchor and of the boreholed substrate by forming a protective anti-rust coating on the anchor.

The anchor plug offers additional advantages by rectifying ‘dimensional mis-matches’ & prevents costly loss of material, time, effort & money, by increasing the surrounding core density & anchoring strength of the surrounding substrate, by postponing age-related disintegration of substrate and by protecting metal-based anchor fasteners from rust & oxidation.

The anchor plug can be used advantageously in the construction Industry. This construction industry primarily uses two types of anchor bolts, a mechanical type which comprises of multiple subtypes & the other an adhesive based anchor bolt, both having their own advantages & disadvantages. Mechanical anchor bolts are quick to install with a major disadvantage that when at the time of insertion, if the concrete is not fully cured & set, the bolt will not get firmly anchored or it will cause small internal cracks within the concrete, thereby decreasing the concrete's long-term structural integrity. Adhesive anchor bolts have the advantage of being chemically fastened to the substrate, thereby eliminating the structural & mechanical issues of the previous, but having disadvantages of increasing costs for the preparation, application & cleaning up after installation. The anchor plug aims to combine the ease of installation of a mechanical anchor bolt with the security and reliability of an adhesive anchor bolt into one.

The anchor plugs when used in DIY home improvement projects offer a simple solution, to an often-vexing problem by correcting the hole-size drilling errors for perfect mating with the anchor plug, by increasing the anchoring strength of the screw-joint & prolongs the life of the joint and importantly leaving no mess behind for any post task additional clean-up.

The anchor plug when used in outdoor recreational activities like mountaineering, especially for rappelling & belaying, would give the climber the advantage of extra weight bearing capacity & increased safety. These anchor plugs would contain low viscosity, fast flowing, instant setting cyanoacrylate-based adhesives and compounds adhesive, which when deployed, into rocky fissures would in addition to the physical anchoring, form strong chemical bonds to give the anchoring hooks, a super strong hold inside the rock fissure & increase the safety margin for the rappeler.

Advantages during installation of the anchor plug are as follows: There is no need to separately mix & inject the adhesives and compounds separately. It does not cause damage to the surrounding area as the spill containment and collection film (11) around the anchor plug, catches the extra seeped out adhesive. The adhesive stays inside, because the elastomeric diaphragm grips & forms a tight seal around the screw shaft, preventing gaps through which the adhesive could potentially leak out and it allows the fitment of a smaller screw & wall-plug into a mistakenly drilled hole of a larger size.

Long term advantages of the anchor plug is that it increases the anchoring strength of the joint, evenly distributes the stresses throughout the entire surface of the hole, extends the life of the joint & the structurally integrity of the substrate & the structure it is holding by preventing the crumbling of the surrounding substrate, the adhesives and compounds would coat the metal (iron/steel/aluminium/brass, etc.) screw & prevent it from degrading over time by preventing the oxidation on the surface of the screw/bolt.

Additionally, in mountaineering, when used for rappelling and belaying, specialized versions, with the same overall design, of the fastener anchor will give the climber the advantage of extra weight bearing capacity and increased safety. These fastener anchors would contain a fast flowing, highly viscous, quick/instant setting adhesives and compounds adhesive, which when deployed, into the surrounding rock fissure, would in a matter of seconds, give the anchor hooks, a super strong grip and increase in its load carrying capacity.

One of the main objectives of the present invention to combine the ease of installation of a mechanical anchor bolt with the security and reliability of an adhesive anchor bolt into one.

The present invention is directed toward providing such a solution, by increasing the anchoring strength of the fastener anchor, by evenly distributing the stresses throughout the entire surface of the hole and by extending the life of the joint and the structurally integrity of the substrate and the structure it supports. Using the anchor plug, reduces the labour time and cost and does not mess up the work area, thereby reducing the clean-up post installation. Using the anchor plug, also has the potential to reduce the cost of inventory holding, by eliminating the need to hold stocks of adhesives and compounds adhesives at the warehouse and construction sites.

To cover the vast variety of potential applications, the anchor plug will be designed & manufactured in a variety of combinations of different size specifications & with different materials for the anchor plug & the inner encapsulated adhesives and compounds. This would be done to factor in for use with different types & materials of screws/bolts, wall/anchoring substrates & environments. The anchor plug may be made of plastic, polymer, fibre, wood, natural materials from nature, metal, alloys, etc, in multiple formats for the design of its expansion joints, slots, hooks, etc. The anchor plug can be of different sizes, dimensions, colours & materials.

It will have different types of expansion slot designs on its external & internal body parts to facilitate a strong anchoring with the external substrate. The physical design of the anchor plug as detailed in the attached figures are only indicative to demonstrate the general form & function of the invention. The designed can be changed and modified to meet the requirements of the objectives of the invention, during the process of manufacturing, storage and transportation.

The spill containment and collection film (11) can be of any shape (round, square, polygonal or any other shape) and size.

The adhesives can be made of polyester resins, cyanoacrylates, epoxy resins, silicones, each as a single part or two/multiple part adhesives that may work independently, or it may react with the body of the anchor plug and get set and get crosslinked.

The raised locking ridges and exit orifices on and in the body of the anchor plug maybe of varied two dimensional or three-dimensional shapes like round, square or any hexagon or polygonal shapes.

It may be used with adhesives single- or two-part epoxies, silicone-based adhesives, cyanoacrylate-based adhesives, etc.

This invention has been described in an illustrative as well as a descriptive manner, and it must be understood that the terminology which has been used is intended to be in the nature of words of description rather than of limitation. Obviously, many modifications and variations of the present invention are possible in light of the above described design and method of operation. For example, the method of attachment of the receptacles containing the adhesive and compound material can be changed depending on the size of shape of the anchor plug design.

1. An anchor plug, according to patent claim 1, characterised in that it comprises, fused within the body of the anchor plug (16), pre-packaged adhesive/s or compounds (20, 21), encapsulated with protective sheath covers (22), sealed with a diaphragm seal plug (15) with an attached spill containment and collection film (11), as a completely pre-assembled unit, ready to use composite anchor plug, without the requirement for a separate or additional adhesive/s or compounds (20, 21) to be inserted, injected or applied from inside or outside the body of the anchor plug for the purposes of additional anchoring support between the anchor, the anchor plug and the drilled borehole in a substrate.

2. The anchor plug, according to patent claim 2, characterised in that, it comprises fused with the body of the anchor plug (16), a diaphragm seal plug (15) with self-sealing, leak-proof properties, designed to retain the generated pressure build up within the cavity of the anchor plug (16), after it is pierced and threaded through, with a threaded or a non-threaded anchor (eg. screw, nail, bolt, etc.) and as the inserted anchor moves forward axially, tearing open the individually encapsulating sheath covers (22) of the encapsulated adhesive or compounds packets (20, 21), releasing the adhesive/s or compounds (20, 21) and with its rotational motion, mixing the adhesive/s or compounds (20, 21) and displacing (due to the subsequent pressure build up within the cavity of the anchor body) this activated adhesive/s or compounds (20, 21) throughout the inside & also to the outside of the anchor body (16), through the discharge vents/exit orifices (18) and the expansion slots (19), onto the external surface of the anchor body, filling the gap/spaces between the anchor body, drilled borehole & the surrounding substrate.

3. The anchor plug, according to patent claim 3, characterised in that, it comprises fused to the to the peripheral top outside edge of the anchor plug body (16), a spill containment and collection film (11), adhesive coated on its under surface (13), insulated with a release liner (14), which when separated and removed from the adhesive backing, exposes the adhesive and when the anchor plug body (16) is pushed into the borehole in the substrate, the spill containment and collection film (11) with applied pressure, adheres securely to the surface surrounding the borehole in the substrate, preventing gaps between the spill containment and collection film (11) and the surface of the substrate and acts as a surface containment device to collect the spilled out excess adhesive/s or compounds (20, 21), in the event of any extra adhesive/s or compounds (20, 21) spilling out from through the pierced diaphragm seal plug (15), or from the space between the anchor plug body and the surrounding substrate, thereby protecting the surrounding surface area of the substrate around the drilled borehole, from contamination and adhesive/s or compounds (20, 21) damage, after which this spill containment and collection film (11) can be subsequently detached and torn off from its tethering to the anchor plug body and discarded.

4. The anchor plug as in claim 1, 2 or 3, characterised in that by the independent use of its partially pre-assembled unit, but comprising of some or all of the other components, consisting of, adhesive/s or compounds (20, 21), it's individual encapsulating sheath covers (22), diaphragm seal plug (15), spill containment and collection film (11), can be used inside the body of another anchor plug for the purposes of the application of adhesive/s or compounds (20, 21) to the inside or outside the body of the anchor plug for additional anchoring support between the anchor, the anchor plug and the drilled borehole in a substrate.

5. The anchor plug as in claim 1, 2 or 3, characterised in that by the independent use of its partially pre-assembled unit, but comprising of some or all of the other components, consisting of, adhesive/s or compounds (20, 21), which may be replaced with other surface protection chemical substances, it's individual encapsulating sheath covers (22), diaphragm seal plug (15), spill containment and collection film (11), can be used inside the body of another anchor plug as a mean/s, for the delivery and application of surface protection chemical substances to the anchor, anchor plug body and substrate.

6. The anchor plug as in claim 1, 2 or 3, characterised in that, the internal adhesive/s or compounds (20, 21) can be replaced with a coating of a catalyst chemical compound over the inside and outside surface of the body of the anchor plug (16), which otherwise would remain inactive, but will catalyse a pre-planned reaction and activate the targeted chemical or adhesive, when released from the confines of its encapsulated protective sheath covers (22) from within the insides of the anchor plug body.

7. The anchor plug as in claim 1, 2 or 3, characterised in that its individual components as independent or partially pre-assembled units, may be packaged together, separately or alongside each other for the purposes of packing, storage and transportation.
